(19) United States
(12) Patent Application Publication
(10) Pub. No.: US 2026/0158900 A1
(43) Pub. Date: Jun. 11, 2026

(54) DRIVING MODULE FOR VEHICLE

(71) Applicants: Hyundai Motor Company, Seoul (KR); Kia Corporation, Seoul (KR)

(72) Inventors: Hyukjoon Kwon, Hwaseong-si (KR); Hyeon Seok Cho, Hwaseong-si (KR); Taeg Ki Kim, Hwaseong-si (KR)

(21) Appl. No.: 19/244,445

(22) Filed: Jun. 20, 2025

(30) Foreign Application Priority Data
Dec. 11, 2024 (KR) 10-2024-0183247

(51) Int. Cl. B60K 7/00; B62D 7/18

(52) U.S. Cl. CPC B60K 7/0007; B62D 7/18; B60K 2007/0038; B60K 2007/0092

(57) ABSTRACT

A vehicle driving system can include a driving/braking system including an in-wheel motor and an electromechanical brake installed in an inner side of a tire rim, a suspension system coupled to a rotational center shaft of the rim, and a steering system provided on an upper portion of the suspension system, wherein the suspension system includes a first knuckle disposed on one side of the rim and coupled to the rotational center shaft, a second knuckle disposed on the other side of the rim and coupled to the rotational center shaft, and one or more damper units connect the steering system to the first knuckle or the second knuckle.

### CROSS-REFERENCE TO RELATED APPLICATIONS

This application claims, under 35 U.S.C. § 119(a), the benefit of priority from Korean Patent Application No. 10-2024-0183247, filed on Dec. 11, 2024, the entire contents of which are incorporated herein by reference.

### TECHNICAL FIELD

The present disclosure relates to a vehicle driving module.

### BACKGROUND

Recently, research and development has been actively conducted on various types of driving modules to be applied to future vehicles. Protean 360+ serving as a vehicle driving module may be an independent driving module having a one-point mount design to implement a steering angle of 90° or higher.

Although the Protean 360+ driving module implements a large steering angle of 90° or higher by utilizing a steering motor disposed on an upper portion thereof, durability thereof may deteriorate due to one-point mount design of the upper portion.

Particularly, the Protean 360+ driving module may omit connecting parts such as a lower control arm and a tie rod, and may independently drive and steer each wheel in the vehicle such that the turning radius is significantly reduced when the vehicle turns.

In addition, the Protean 360+ driving module may have a steering angle of ±180°, and the Mobis e-Corner driving module may have a steering angle of ±90°.

Further, the Schaeffler Corner Module is a driving module configured to have a four-point mount design for driving stability. The Schaeffler Corner Module may include parts such as a lower control arm and a tie rod and may have a steering angle of −90° to +45°.

Particularly, the Schaeffler Corner Module may be advantageous in durability and driving stability as compared with a driving module having a one-point mount design. The Schaeffler Corner Module has a limitation in providing only a steering angle of less than 90° due to a mechanical link coupling structure thereof.

Therefore, there is a demand for a driving module capable of providing driving stability and a large steering angle.

The above information disclosed in this Background section is only for enhancement of understanding of the background of the disclosure, and therefore it may contain information that does not form the prior art that is publicly known, available, or in use.

### SUMMARY

The present disclosure relates to a vehicle driving module, and more particularly, to a vehicle driving module configured to secure high stability against external force in the horizontal direction of the vehicle as well as external force in the height direction of the vehicle, and to integrate a driving/braking system, a steering system, and a suspension system with each other to enable large-angle steering.

An embodiment of the present disclosure can solve the above-described problems associated with the prior art, and can provide a driving module having high stability against horizontal external force through a plurality of damper units integrally coupled to a knuckle and a plurality of joints respectively coupled to the damper units and disposed orthogonal to each other.

An embodiment of the present disclosure can provide a driving module including a plurality of coupling holes formed in a knuckle and damper units respectively inserted into and fixed in the coupling holes, thereby securing driving stability of a vehicle when a wheel bumps and rebounds due to an uneven road surface.

Advantages of embodiments of the present disclosure are not necessarily limited to the above-mentioned advantages, and other technical advantages not mentioned herein can be understood by those skilled in the art to which the present disclosure pertains from the detailed description of the example embodiments. Advantages of embodiments of the present disclosure may be achieved by systems, components, and combinations thereof as indicated in the claims.

In an embodiment of the present disclosure, a vehicle driving module can include a driving/braking system including an in-wheel motor and an electromechanical brake (EMB-based brake) installed in an inner side of a rim of a tire, a suspension system coupled to a rotational center shaft of the rim, and a steering system provided on an upper portion of the suspension system, wherein the suspension system includes a first knuckle disposed on one side of the rim and coupled to the rotational center shaft, a second knuckle disposed on the other side of the rim and coupled to the rotational center shaft, and one or more damper units configured to connect the steering system to the first knuckle or the second knuckle.

In an embodiment, the steering system may include a first steering member configured to be fixed to a vehicle body, and a second steering member located on an inner side of the first steering member, the second steering member having a lower portion coupled to the suspension system.

In an embodiment, one end of the damper unit may be connected to the second steering member, and the other end thereof may be connected to the first knuckle or the second knuckle by a revolute joint pin.

In an embodiment, the revolute joint pin connecting the first knuckle to the damper unit and the revolute joint pin connecting the second knuckle to the damper unit may be configured such that longitudinal central axes of the respective revolute joint pins are orthogonal to each other in the same plane parallel to the ground.

In an embodiment, the first knuckle or the second knuckle may have a coupling hole configured for a part of the damper unit to be located therein.

In an embodiment, the coupling hole may be configured to form a clearance between the first knuckle or the second knuckle and the damper unit.

In an embodiment, the vehicle driving module may further include a first revolute joint pin coupled to the damper unit connected to a left side of the first knuckle when viewed from the first knuckle side toward the rim, a second revolute joint pin coupled to the damper unit connected to a right side of the first knuckle when viewed from the first knuckle side toward the rim, a third revolute joint pin coupled to the damper unit connected to a left side of the second knuckle when viewed from the second knuckle side toward the rim, and a fourth revolute joint pin coupled to the damper unit connected to a right side of the second knuckle when viewed from the second knuckle side toward the rim.

In an embodiment, a longitudinal center axis of the first revolute joint pin and a longitudinal center axis of the second revolute joint pin may be configured to be orthogonal to each other in the same plane parallel to the ground.

In an embodiment, a longitudinal center axis of the third revolute joint pin and a longitudinal center axis of the fourth revolute joint pin may be configured to be orthogonal to each other in the same plane parallel to the ground.

In an embodiment, a longitudinal center axis of the first revolute joint pin and a longitudinal center axis of the third revolute joint pin may be configured to be parallel to each other in the same plane parallel to the ground.

In an embodiment, a longitudinal center axis of the second revolute joint pin and a longitudinal center axis of the fourth revolute joint pin may be configured to be parallel to each other in the same plane parallel to the ground.

In an embodiment, the first revolute joint pin and the fourth revolute joint pin may be configured to be located at points symmetrical to each other relative to the rim in the same plane parallel to the ground.

In an embodiment, the second revolute joint pin and the third revolute joint pin may be configured to be located at points symmetrical to each other relative to the rim in the same plane parallel to the ground.

In an embodiment, the rotational center shaft may protrude from an outer surface of the rim so as to be inserted into an insertion groove formed in each of the first knuckle and the second knuckle.

The terms “vehicle”, “vehicular”, and other similar terms as used herein can be inclusive of motor vehicles in general, such as passenger automobiles including sport utility vehicles (SUVs), buses, trucks, various commercial vehicles, watercraft including a variety of boats and ships, aircraft, tractors, forklifts, and the like, and can include hybrid vehicles, electric vehicles, plug-in hybrid electric vehicles, hydrogen-powered vehicles, and other alternative fuel vehicles (e.g., fuels derived from resources other than petroleum). As referred to herein, a hybrid vehicle can be a vehicle that has two or more sources of power, for example, vehicles powered by both gasoline and electricity.

### BRIEF DESCRIPTION OF THE DRAWINGS

The above and other features of example embodiments of the present disclosure will now be described in detail with reference to the accompanying drawings, which are given hereinbelow by way of illustration, and thus are not necessarily limitative of the present disclosure, and wherein:

FIG. 1 is a side view of a vehicle driving module according to an embodiment of the present disclosure;

FIG. 2 is a front view of a vehicle driving module according to an embodiment the present disclosure;

FIG. 3 is a configuration diagram including some cross-section views and showing a driving/braking system of the vehicle driving module according to an embodiment the present disclosure;

FIG. 4 is a configuration diagram showing a steering system and a power supply structure of a vehicle driving module according to an embodiment the present disclosure;

FIG. 5 is a cross-sectional view taken along line A-A in FIG. 4;

FIG. 6 is a cross-sectional view taken along line B-B in FIG. 4;

FIG. 7 is a perspective view of a suspension system according to an embodiment the present disclosure;

FIG. 8 is a top view of a joint configuration of a suspension system according to an embodiment the present disclosure;

FIG. 9 is a perspective view of a suspension system according to an embodiment of the present disclosure; and

FIG. 10 is a front view of a suspension system according to an embodiment of the present disclosure.

It can be understood that the appended drawings are not necessarily to scale, presenting a somewhat simplified representation of various features illustrative of some basic principles of example embodiments of the present disclosure. The specific design features of an embodiment of the present disclosure as disclosed herein, including, for example, specific dimensions, orientations, locations, and shapes can be determined in part by a particular intended application and use environment.

In the figures, reference numbers can refer to same or equivalent parts of some embodiments of the present disclosure throughout the several figures of the drawing.

### DETAILED DESCRIPTION OF ILLUSTRATIVE EMBODIMENTS

Hereinafter, reference will be made in detail to various example embodiments of the present disclosure, which are illustrated in the accompanying drawings and described below. While the present disclosure will be described in conjunction with example embodiments, it can be understood that the present description is not intended to necessarily limit the present disclosure to the example embodiments. On the contrary, the present disclosure is intended to cover not only the example embodiments, but also various alternatives, modifications, equivalents, and other embodiments, which may be included within the spirit and scopes of the present disclosure as defined by the appended claims.

As used herein, the suffixes “module” and “part” can be used only for differentiation between components, and are not to be necessarily construed as implying that the components are separated or otherwise capable of being separated physically and chemically.

Terms such as “first” and/or “second” may be used herein to describe various elements in the present disclosure, but these elements are not to be necessarily construed as being limited by such terms. Such terms can be used only for the purpose of differentiating one element from other elements in the present disclosure. The sequential meaning of such terms can be determined not necessarily by names of the terms and through the context of descriptions thereof.

The term “and/or” can be used to include any combination of multiple items in question. For example, “A and/or B” can include all three cases, i.e., “A”, “B”, and “A and B”.

When one component is referred to as being “connected” or “joined” to another component, the one component may be directly connected or joined to the other component, and it can be understood that other components may be present therebetween.

Same reference numerals can represent same components throughout the specification. Terms in the specification can be used merely to describe example embodiments and are not intended to necessarily limit the present disclosure. In this specification, an expression in a singular form also can include a plural form, unless clearly specified otherwise in context. It can be understood that expressions such as “comprise” and “have” in this specification are intended to designate the presence of indicated features, numbers, steps, operations, components, parts, or combinations thereof, but do not exclude the presence or addition of one or more features, numbers, steps, operations, components, parts, or combinations thereof.

Terms used herein, including technical and scientific terms, can have same meanings as those commonly understood by those skilled in the art. Terms such as those defined in commonly used dictionaries can be interpreted as having meanings that are consistent with their meanings in the context of the relevant art and the present disclosure.

Next, each component of an example embodiment of the present disclosure will be described in detail with reference to the accompanying drawings.

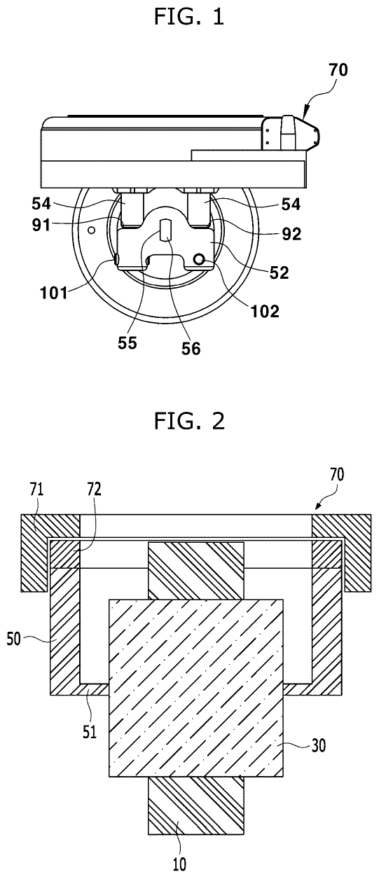

A vehicle driving module according to an embodiment of the present disclosure may be configured to include a driving/braking system 30, a suspension system 50, and a steering system 70, as shown in FIGS. 1 and 2.

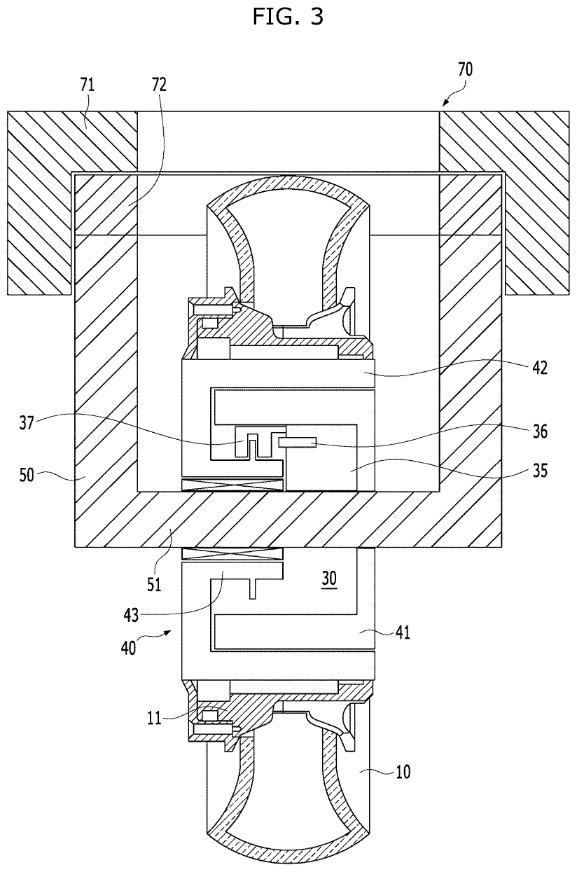

As shown in FIG. 3, a driving/braking system 30 may be configured to be implemented by an in-wheel motor 40 and an electromechanical brake (EMB) 35 installed in an inner space of a rim 11 of a tire 10.

The rim 11 of the tire 10 can be a circular rigid member including a wheel, and the tire can be coupled to the rim in a state of surrounding the outer wheel of the rim. The rim 11 may include a hollow portion having a predetermined size capable of accommodating the in-wheel motor 40 and the electromechanical brake (EMB) 35.

The suspension system 50 may be located on at least one of the left and right sides of the driving/braking system 30, and a suspension support shaft 51 may be fixedly installed to form a rotational center shaft 51 of the rim 11. A spring or a fluid damper element may be utilized as a plurality of damper units 54.

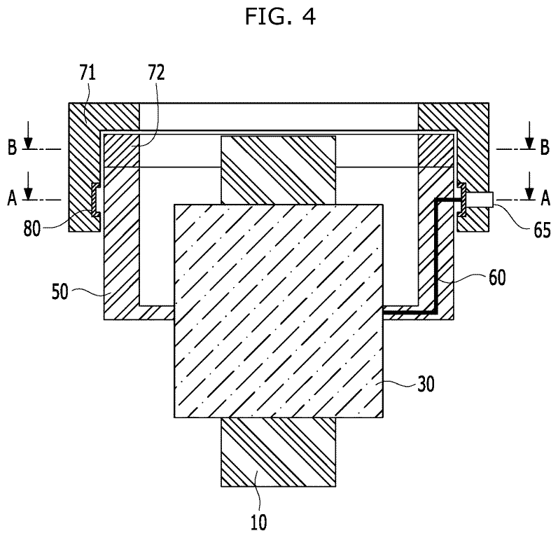

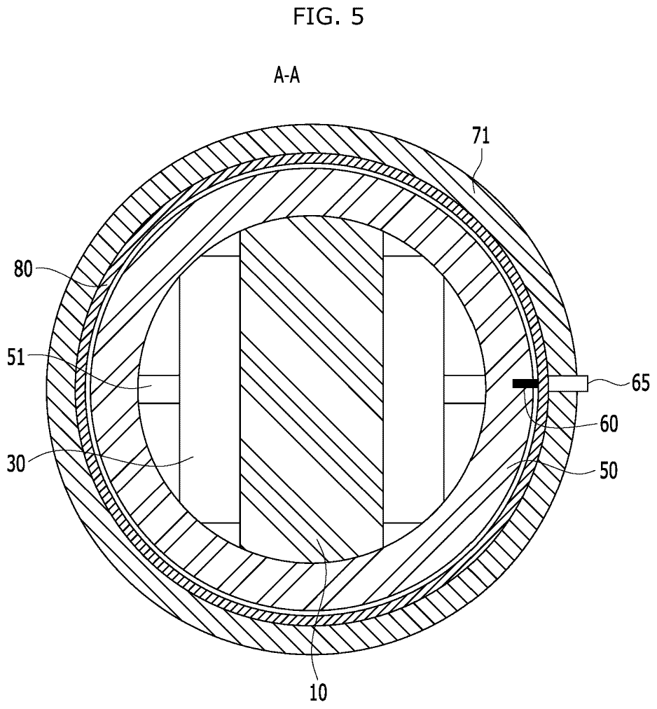

As shown in FIGS. 4 to 6, the steering system 70 may include a disc-shaped first steering member 71 located on the upper side of the suspension system 50 and attached to the lower portion of a vehicle body, a second steering member 72 located on the inner side of the first steering member and attached to the upper portion of the suspension system 50, and a steering driving unit 73 configured to drive rotation of the second steering member 72. In this manner, the packaging space formed on the upper portion of the tire 10 may be minimized, thereby implementing a full flat shape.

Hereinafter, a detailed description will be given as to the driving/braking system 30, the suspension system 50, and the steering system 70 included in the vehicle driving module according to an embodiment of the present disclosure.

### Driving/Braking System

The driving/braking system may be configured to be implemented by utilizing the in-wheel motor 40 and the EMB-based disc brake 35, as shown in FIG. 3.

In this example, the in-wheel motor 40 can be a motor installed in the inner space of the rim 11 of the tire 10 and configured to directly transmit power to the rim, and an internal or external motor may be used as the in-wheel motor.

In particular, as shown in FIG. 3, when power is applied to a stator 41 including stator windings (not shown) made of a conductive material, the in-wheel motor 40 of the driving/braking system 30 can be configured to rotate a disc 43 in a state in which a rotor 42 serving as a permanent magnet rotates the rim 11.

Particularly, the suspension support shaft 51 of the suspension system 50 may be configured to form the rotational center shaft 51 of the rim 11, and the rotor 42 may be configured to rotate the rim 11 and the disc 43 around the suspension support shaft 51. Furthermore, the suspension support shaft 51 can include a protrusion 56 protruding from opposite ends of the outer surface of the rim 11. The protrusion 56 may be inserted into an insertion groove 55 located in a first knuckle 52 and a second knuckle 53. The protrusion 56 may be configured to have a set, selected, or predetermined shape so as to be inserted into and fixed to the insertion groove 55 of the first knuckle 52 and the second knuckle 53 and to allow the rim 11 to be rotated around the first knuckle 52 and the second knuckle 53.

The driving/braking system 30 may utilize the EMB-based brake 35 configured to electronically brake the rotating disc 43 with a brake pad 37 driven by an actuator 36. The electromechanical brake (EMB) may be configured to electronically control the operation of a brake.

In this example, the EMB-based brake 35 according to an embodiment the present disclosure may be configured to eliminate a hydraulic line that may limit the steering angle by being converted into a mechanical type that does not necessarily require a hydraulic line of a hydraulic brake.

The electromechanical brake may control braking force more precisely than a hydraulic brake and may be automatically operated when an autonomous driving system is applied, thereby increasing user convenience and improving vehicle technology.

Particularly, an embodiment of the present disclosure may use a braking system utilizing an EMB-based disc or drum. In an electromechanical drum brake, rotational torque can be additionally generated by self-servo action causing a brake shoe pressed by a drum to be rotated with the drum, thereby increasing braking force (braking torque).

### Steering System

The steering system 70 may include the first steering member 71 and the second steering member 72, as shown in FIG. 4. The first steering member 71, which may be formed in a roughly disc shape, may be fixedly coupled to the lower portion of the vehicle body, and the second steering member 72, which may be formed in a ring shape, may be built into the first steering member 71 and may be coupled to the upper portion of the suspension system 50.

The steering system 70 can have a structure in which the first steering member 71 having a roughly circular shape and the second steering member 72 having a ring shape can be stacked in the vertical direction. In this manner, the packaging space formed between the tire 10 and the lower vehicle body may be maximally reduced, thereby making it possible not only to implement a full-flat shape, but also to improve durability through multiple mounting points on the vehicle body.

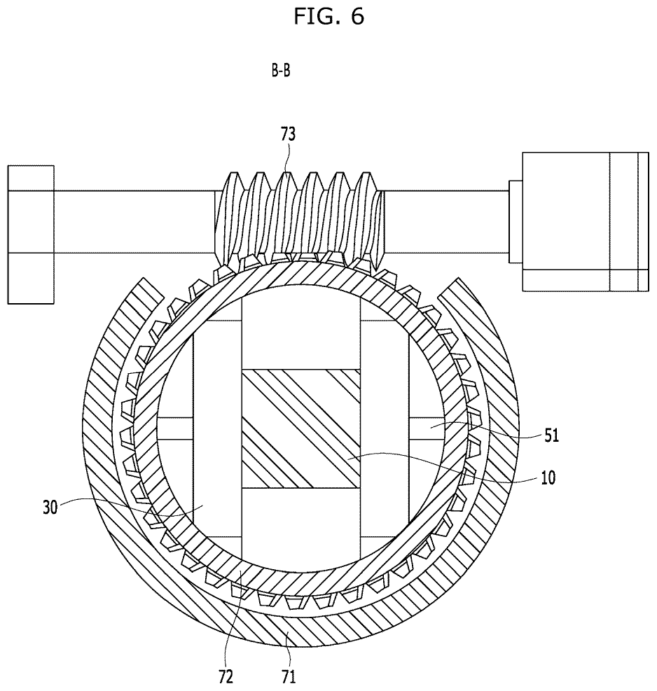

In detail, as shown in FIG. 6, the steering system 70 may include the disc-shaped first steering member 71 located on the upper side of the suspension system 50 and attached to the lower portion of the vehicle body, the second steering member 72 located on the inner side of the first steering member and configured for the upper portion of the suspension system 50 to be attached to the lower portion thereof, and the steering driving unit 73 configured to drive rotation of the second steering member 72.

In this example, the second steering member 72 and the steering driving unit 73 may have gear structures so as to be engaged with each other. If the steering driving unit is a worm gear, the second steering member may be a worm wheel, and the steering driving unit may be rotated by a driving motor.

Therefore, when the steering driving unit 73 is driven, the second steering member 72 is rotated, and the suspension system 50 is rotated by a steering angle to change the direction of the tire 10.

### Power Supply Structure

In the vehicle driving module, the driving/braking system 30 may be installed in the rim 11 of the tire 10, and the steering angle of the tire controlled by the steering system 70 may be limited by a power supply structure configured to supply power to the driving/braking system 30.

As shown in FIG. 4, the power supply structure of the vehicle driving module may be configured such that a ring-type power connection unit 80 may be fixedly provided on the inner surface of the first steering member 71 of the steering system 70, and a first power supply part 65 may be provided on one side of the first steering member 71.

In this example, the power connection unit 80 may be configured such that the first power supply part 65 is electrically connected to one side of the ring-shaped outer surface of the power connection unit, and the first power supply part may be configured to receive external power.

A second power supply part 60 can be built into one side of the suspension system 50, and the upper portion of the second power supply part 60 may be electrically connected along the inner surface of the ring of the power connection unit 80.

The lower portion of the second power supply part 60 may be electrically connected to the in-wheel motor 40 and the EMB-based disc brake 35.

In detail, in the power supply structure of the vehicle driving module, when the suspension system 50 is rotated by the steering angle with the second steering member 72 of the steering system 70, the second power supply part 60 may be configured to supply power to the in-wheel motor 40 and the EMB-based disc brake 35 while rotating along the inner circumferential surface of the ring of the power connection unit 80 in a state in which the upper end of the second power supply part is electrically connected to the inner circumferential surface of the ring of the power connection unit 80 in a fixed state.

The power supply structure of the vehicle driving module may include the second power supply part 60, the first power supply part 65, and the power connection unit 80. When the steering angle of the tire 10 is controlled by the steering system 70, the steering angle is not necessarily limited by a power supply structure and the like, thereby making it possible to readily implement a steering angle without limitation.

### Suspension System

As shown in FIG. 1 and FIGS. 7 and 8, the suspension system 50 can include the first knuckle 52 and the second knuckle 53 respectively located on the left side and the right side of the tire 10. The first and second knuckles can include a plurality of coupling holes 91, 92, 93, and 94 into which the damper units 54 are respectively inserted. The first knuckle 52 and the second knuckle 53 are configured to surround opposite sides of the suspension support shaft 51 located on the rotational center shaft 51 of the tire 10. Furthermore, the knuckles 52 and 53 are respectively located on opposite sides of the tire 10 and include the coupling holes 91, 92, 93, and 94 configured for a plurality of damper units 54 to be inserted thereinto and coupled thereto. Each of the damper units 54 has one end located on the second steering member and the other end connected to a corresponding one of the knuckles 52 and 53. Furthermore, each of the damper units 54 can be inserted into a corresponding one of the coupling holes 91, 92, 93, and 94 such that the adjacent damper units 54 can be spaced apart from each other with an equal interval therebetween.

In the embodiment of the present disclosure, the knuckles 52 and 53 can be formed of the first knuckle 52 located on one side of the rim and the second knuckle 53 located on the other side of the rim. The first knuckle 52 can include the first coupling hole 91 formed in one end of the first knuckle 52 and the second coupling hole 92 formed in the other end thereof. The second knuckle 53 can include the third coupling hole 93 formed in one end of the second knuckle 53 and the fourth coupling hole 94 formed in the other end thereof. The first coupling hole 91 and the second coupling hole 92 can be formed in the first knuckle 52 and can be located adjacent to each other in the longitudinal direction of the rim. The third coupling hole 93 and the fourth coupling hole 94 can be formed in the second knuckle 53 and can be located adjacent to each other in the longitudinal direction of the rim. Furthermore, at least a part of each of the damper units 54 may be inserted into and fixed in a corresponding one of the first coupling hole to the fourth coupling hole 91, 92, 93, and 94 respectively located at the first knuckle 52 and the second knuckle 53.

According to an embodiment of the present disclosure, the first coupling hole 91 formed in the first knuckle 52 and the fourth coupling hole 94 formed in the second knuckle 53 can be located at the longitudinal front end of the rim, and the second coupling hole 92 formed in the first knuckle 52 and the third coupling hole 93 formed in the second knuckle 53 can be located at the longitudinal rear end of the rim.

An embodiment of the present disclosure can include a first revolute joint pin 101, a second revolute joint pin 102, a third revolute joint pin 103, and a fourth revolute joint pin 104. At least a part of the first revolute joint pin can be inserted into the first coupling hole 91, at least a part of the second revolute joint pin can be inserted into the second coupling hole 92, at least a part of the third revolute joint pin can be inserted into the third coupling hole 93, and at least a part of the fourth revolute joint pin can be inserted into the fourth coupling hole 94. The first to fourth revolute joint pins 101, 102, 103, and 104 may be inserted into insertion holes formed in the coupling holes 91, 92, 93, and 94, respectively. Furthermore, the first revolute joint pin to the fourth revolute joint pin 101, 102, 103, and 104 can be configured to be integrally inserted into the coupling holes 91, 92, 93, and 94 and the damper units 54 respectively inserted into the coupling holes 91, 92, 93, and 94, thereby fixing the damper units 54 to the respective coupling holes 91, 92, 93, and 94. Each of the first revolute joint pin to the fourth revolute joint pin 101, 102, 103, and 104 may be formed of a revolute joint.

In this manner, each of the damper units 54 may be located in a corresponding one of the coupling holes 91, 92, 93, and 94 respectively located on the opposite sides of the first knuckle 52 and the second knuckle 53, and the upper ends thereof may be coupled to the lower end of the steering system 70.

In particular, the suspension system 50 may be configured to improve durability thereof by forming multiple mounting points on the suspension system in a state in which the upper end of the suspension system is coupled to the second steering member 72 of the steering system 70. The respective upper ends of the damper units 54 may be coupled to the second steering member 72 through the multiple mounting points, and the lower ends thereof may be jointly coupled to the first knuckle 52 and the second knuckle 53, respectively.

The first revolute joint pin 101 and the third revolute joint pin 103 can be respectively inserted into the first coupling hole 91 and the third coupling hole 93 so as to have the same directionality and can be configured to be symmetrical with respect to a rotation center point of the rim. The first revolute joint pin 101 and the third revolute joint pin 103 can be respectively inserted into the insertion holes respectively formed in the first coupling hole 91 and the third coupling hole 93. The insertion holes can be formed in the longitudinal direction of the vehicle body. The damper units 54 respectively inserted into the first coupling hole 91 and the third coupling hole 93 and the respective knuckles 52 and 53 can be mutually fixed to each other by the first revolute joint pin 101 and the third revolute joint pin 103, respectively.

The second revolute joint pin 102 and the fourth revolute joint pin 104 can be respectively inserted into the second coupling hole 92 and the fourth coupling hole 94 so as to have the same directionality and can be configured to be symmetrical with respect to the rotation center point of the rim. The second revolute joint pin 102 and the fourth revolute joint pin 104 can be respectively inserted into the second coupling hole 92 and the fourth coupling hole 94 in the width direction of the vehicle. The second revolute joint pin 102 and the fourth revolute joint pin 104 can be respectively inserted into the second coupling hole 92 and the fourth coupling hole 94 in an insertion direction of the outer side of the rim to the inner side thereof. That is, an insertion direction of the insertion hole of each of the first revolute joint pin 101 and the third revolute joint pin 103 and an insertion direction of the insertion hole of each of the second revolute joint pin 102 and the fourth revolute joint pin 104 can be orthogonal to each other in the same plane in the height direction. In this way, the insertion holes respectively located in the first to fourth coupling holes 91, 92, 93, and 94 can be configured to have the same height, and the two insertion holes can be shapes parallel to each other. Two insertion holes parallel to each other may be located in a direction orthogonal to the other two insertion holes adjacent thereto. That is, the first revolute joint pin 101 and the third revolute joint pin 103 can be configured to be parallel to each other, and the second revolute joint pin 102 and the fourth revolute joint pin 104 can be configured to be parallel to each other.

The first revolute joint pin and the fourth revolute joint pin can be located at points symmetrical to each other relative to the rim on the same plane parallel to the ground, and the second revolute joint pin and the third revolute joint pin can be located at points symmetrical to each other relative to the rim on the same plane parallel to the ground.

Each of the first to fourth coupling holes 91, 92, 93, and 94 can be configured to have a hole shape formed to pass through a corresponding one of the first and second knuckles in the height direction of the vehicle. The damper units 54 can be respectively inserted into the first to fourth coupling holes 91, 92, 93, and 94 and can be respectively fixed to the first knuckle 52 and the second knuckle 53 through the first to fourth revolute joint pins 101, 102, 103, and 104. The first to fourth revolute joint pins 101, 102, 103, and 104 can be inserted into the respective insertion holes in the coupling holes 91, 92, 93, and 94 in a direction perpendicular to a direction in which the damper units 54 are respectively inserted into the coupling holes, and at least two revolute joint pins can be coupled to the knuckles 52 and 53 in a direction parallel to each other.

That is, the two knuckles 52 and 53 can be respectively located on the opposite sides of the rim respectively and can include two coupling holes 91 and 92 and two coupling holes 93 and 94. The revolute joint pins 101, 102, 103, and 104 can have shapes orthogonal to each other. The revolute joint pins can be respectively inserted into the coupling holes 91, 92, 93, and 94 such that the damper units 54 respectively inserted into the coupling holes and the knuckles 52 and 53 can be integrally fixed to each other. Therefore, two revolute joint pins 101 and 102 located in the knuckle 52 can be inserted into the knuckle in the directions orthogonal to each other with respect to the same height, and the same can apply to the two revolute joint pins 103 and 104. Furthermore, when external force corresponding to the direction in which each of the revolute joint pins 101, 102, 103, and 104 is inserted into a corresponding one of the knuckles is applied, the damper units 54 and the knuckles may secure flexibility and robustness against external force.

The first to fourth revolute joint pins 101, 102, 103, and 104 respectively inserted into the coupling holes 91, 92, 93, and 94 may each include a bushing 105. Therefore, the first revolute joint pin 101 and the third revolute joint pin 103 can be formed in the longitudinal direction of the vehicle, and the bushing 105 located at the first revolute joint pin 101 and the bushing 105 located at the third revolute joint pin 103 may provide flexibility against external disturbance in the longitudinal direction of the vehicle. Conversely, the second revolute joint pin 102 and the fourth revolute joint pin 104 can be formed in the width direction of the vehicle, and the bushing 105 located at the second revolute joint pin 102 and the bushing 105 located at the fourth revolute joint pin 104 may provide flexibility against external disturbance in the width direction of the vehicle.

The revolute joint pins respectively located in the longitudinal direction and the width direction of the vehicle can have shapes symmetrical to each other relative to a center point of the rim, thereby providing stability along the four axes of the suspension system.

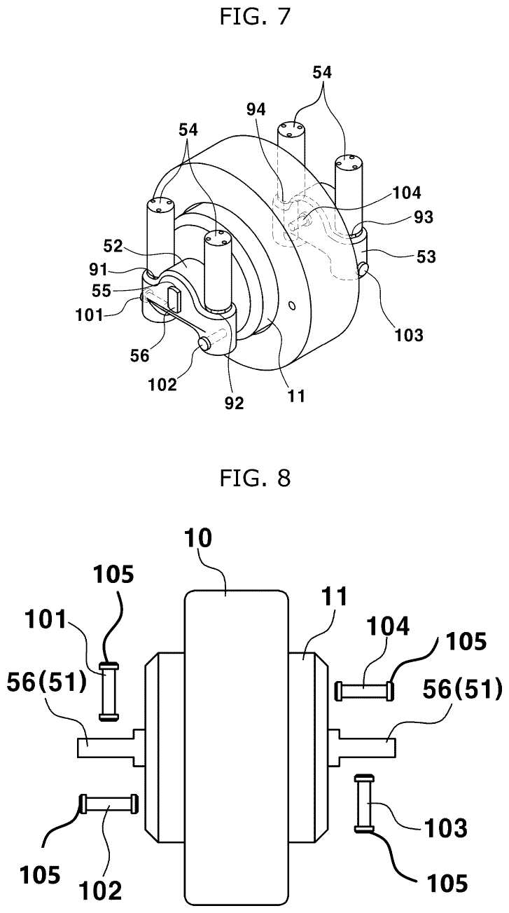

Furthermore, FIG. 7 shows the insertion groove 55 can be formed in the first knuckle 52 and the second knuckle 53, which can be coupled to the suspension support shaft 51 penetrating the rim.

As shown in the drawing, the suspension support shaft 51 can include the protrusion 56 penetrating the outer surface of the rim. The protrusion 56 can protrude from the opposite sides of the rim.

The suspension support shaft 51 of an embodiment of the present disclosure may be fixedly installed to form the rotational center shaft 51 of the rim 11, and the rim may be rotated along the outer surface of the suspension support shaft 51. The rotor 42 may be provided so as to allow the rim 11 and the disc 43 to be rotated around the suspension support shaft 51.

The protrusion 56 can be configured to be coupled to the first knuckle 52 and the second knuckle 53 respectively located on the opposite sides of the rim 11. Each of the first knuckle 52 and the second knuckle 53 can include the insertion groove 55 corresponding to the protrusion 56 of the suspension support shaft 51. The insertion groove 55 can be configured such that at least two surfaces of the insertion groove are in contact with the protrusion 56 of the suspension support shaft 51. Accordingly, the suspension support shaft 51 and the knuckles 52 and 53 can be coupled to each other in a state in which the protrusion 56 is inserted into the inner side of the insertion groove 55.

According to an embodiment of the present disclosure, the protrusion 56 may be formed to have two parallel surfaces, and the insertion groove 55 corresponding to the shape of the protrusion 56 may be provided. The protrusion 56 and the insertion groove 55 may be coupled to each other through a conventional method so as to couple the first knuckle 52 and the second knuckle 53 to the suspension support shaft 51 in a state in which the protrusion is inserted into the insertion groove 55.

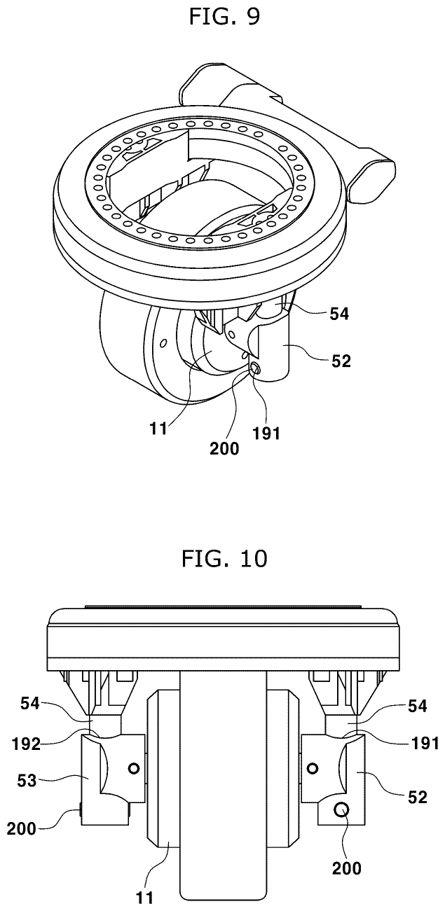

As shown in FIGS. 9 and 10, the suspension system 50 according to an embodiment can include the first knuckle 52 and the second knuckle 53 respectively located on the left and right sides of the tire 10. The first knuckle 52 and the second knuckle 53 respectively can include coupling holes 191 and 192 into which the damper units 54 can be respectively inserted. The first knuckle 52 and the second knuckle 53 can be configured to surround the opposite sides of the suspension support shaft 51 located at the rotational center shaft 51 of the tire 10. Furthermore, the knuckles 52 and 53 respectively can be located on the opposite sides of the tire 10 and respectively can include the coupling holes 191 and 192 configured to allow the respective damper units 54 to be inserted into and coupled thereto.

According to an embodiment of the present disclosure, the knuckles 52 and 53 can be each formed of the first knuckle 52 located on one side of the rim and the second knuckle 53 located on the other side of the rim. Further, the first coupling hole 191 can be located in the first knuckle 52, and the second coupling hole 193 can be located in the second knuckle 53. At least a part of each of the damper units 54 may be inserted into and fixed in a corresponding one of the first coupling hole and the second coupling hole 191 and 192 respectively located in the first knuckle 52 and the second knuckle 53.

In an embodiment of the present disclosure, revolute joint pins 200 can be respectively inserted into the first coupling hole 191 located in the first knuckle 52 and the second coupling hole 192 located in the second knuckle 53.

The revolute joint pins 200 can be integrally inserted into the respective coupling holes 191 and 192, and the respective damper units 54 can be inserted into the respective coupling holes 191 and 192. In this manner, the damper units 54 and the coupling holes 191 and 192 can be fixed to each other.

In particular, the suspension system 50 may be configured to improve durability thereof by forming multiple mounting points on the suspension system in a state in which the upper end of the suspension system is coupled to the second steering member 72 of the steering system 70. The respective upper ends of the damper units 54 may be coupled to the second steering member 72 through the multiple mounting points, and the lower ends thereof may be jointly coupled to the first knuckle 52 and the second knuckle 53, respectively.

The revolute joint pin 200 on one side of the rim and the revolute joint pin 200 on the other side thereof can be respectively located in the first coupling hole 191 and the second coupling hole 192 so as to have different directions and can be configured to be symmetrical to each other on the opposite sides of the rim. The revolute joint pin 200 located in the first coupling hole 191 can be located in an insertion hole formed in the longitudinal direction of the vehicle. The revolute joint pin 200 inserted into the second coupling hole 192 can be inserted into an insertion hole formed in the outer width direction of the rim. That is, the damper units 54 respectively inserted into the first coupling hole 191 and the second coupling hole 192 through two revolute joint pins 200 can be located to enable the knuckles 52 and 53 to be fixed to each other.

In this manner, according to an embodiment of the present disclosure, an insertion direction (longitudinal direction of the pin) of the revolute joint pin 200 located in the first coupling hole 191 and an insertion direction of the revolute joint pin 200 located in the second coupling hole 192 can be orthogonal to each other in the same plane in the height direction.

That is, the two knuckles 52 and 53 respectively located on the opposite sides of the rim respectively can include the coupling holes 191 and 192. The revolute joint pins 200 can have shapes orthogonal to each other in the same plane in the height direction. The revolute joint pins can be respectively inserted into the coupling holes 191 and 192 such that the damper units 54 respectively inserted into the coupling holes 191 and 192 and the knuckles 52 and 53 can be integrally fixed to each other. Furthermore, when external force corresponding to a direction in which each of the revolute joint pins 200 is inserted into a corresponding one of the knuckles is applied, the damper units 54 and the knuckles 52 and 53 may secure flexibility and robustness against external force.

As in an embodiment illustrated in FIG. 8, the revolute joint pins 200 respectively inserted into the coupling holes 191 and 192 (as illustrated in FIGS. 9 and 10) may each include a bushing 105. The bushings 105 can be respectively inserted into the revolute joint pins 200, which can be inserted into the respective coupling holes in the directions orthogonal to each other and may provide flexibility against external disturbance in the longitudinal direction of the vehicle and flexibility against external disturbance in the width direction of the vehicle.

Furthermore, the revolute joint pins located in the longitudinal direction and the width direction can be respectively located in the knuckles 52 and 53 that can be respectively on the opposite sides of the rim and are symmetrical to each other, thereby providing stability to the suspension system.

As can be apparent from the above description, an embodiment of the present disclosure may achieve the following effects and/or advantages by the configuration, combination, and use relationship described in the example embodiments.

An embodiment of the present disclosure can provide a suspension system including a joint connection structure having different angles of a plurality of damper units respectively located on opposite sides of a rim, thereby having an effect of securing stability in response to external force of a vehicle.

An embodiment of the present disclosure can provide a suspension system including a plurality of damper units integrally coupled to respective knuckles, thereby maintaining the posture of a wheel and providing a driving module capable of providing high driving stability of a vehicle.

A number of embodiments have been disclosed herein. It can be understood that various features of the different embodiments can be combined.

Although the present disclosure has been described in detail with reference to example embodiments thereof, the scopes of the present disclosure are not necessarily limited to the above-described example embodiments and the accompanying drawings thereof, and it can be appreciated by those skilled in the art that various modifications and improvements may be made in the example embodiments without departing from the principles and spirit of the disclosure. Therefore, the example embodiments should be considered illustrative rather than necessarily restrictive. Accordingly, the present disclosure is not necessarily limited to the example embodiments and may be modified within the scopes of the appended claims and equivalents thereto.

What is claimed is:

1. A vehicle driving system comprising:
a driving/braking system comprising an in-wheel motor and an electromechanical brake installed in a rim inner side of a rim of a tire;
a suspension system coupled to a rotational center shaft of the rim; and
a steering system provided on an upper portion of the suspension system,
wherein the suspension system comprises:
a first knuckle disposed on a first side of the rim and coupled to the rotational center shaft,
a second knuckle disposed on a second side of the rim and coupled to the rotational center shaft, and
one or more damper units connect the steering system to the first knuckle or the second knuckle.

2. The vehicle driving system of claim 1, wherein the steering system comprises:
a first steering member configured to be fixed to a vehicle body; and
a second steering member located on a first-steering-member inner side of the first steering member, the second steering member having a lower portion coupled to the suspension system.

3. The vehicle driving system of claim 2, wherein a first damper-unit end of the one or more damper units is connected to the second steering member, and a second damper-unit end of the one or more damper units is connected to the first knuckle or the second knuckle by a revolute joint pin.

4. The vehicle driving system of claim 3, wherein a first revolute joint pin connecting the first knuckle to a first damper unit of the one or more damper units and a second revolute joint pin connecting the second knuckle to a second damper unit of the one or more damper units are configured such that longitudinal central axes of the first and second revolute joint pins are orthogonal to each other in a same plane parallel to ground.

5. The vehicle driving system of claim 3, wherein the first knuckle or the second knuckle has a coupling hole configured for a part of a given damper unit of the one or more damper units to be located therein.

6. The vehicle driving system of claim 5, wherein the coupling hole is configured to form a clearance between the first knuckle or the second knuckle and the given damper unit.

7. The vehicle driving system of claim 3, further comprising:
a first revolute joint pin coupled to a first damper unit of the one or more damper units connected to a left first-knuckle side of the first knuckle when viewed from a first-knuckle side view toward the rim;
a second revolute joint pin coupled to a second damper unit of the one or more damper units connected to a right first-knuckle side of the first knuckle when viewed from the first-knuckle side view toward the rim;
a third revolute joint pin coupled to a third damper unit of the one or more damper units connected to a left second-knuckle side of the second knuckle when viewed from a second-knuckle side view toward the rim; and
a fourth revolute joint pin coupled to a fourth damper unit of the one or more damper units connected to a right second-knuckle side of the second knuckle when viewed from the second-knuckle side view toward the rim.

8. The vehicle driving system of claim 7, wherein a first longitudinal center axis of the first revolute joint pin and a second longitudinal center axis of the second revolute joint pin are configured to be orthogonal to each other in a same plane parallel to ground.

9. The vehicle driving system of claim 7, wherein a third longitudinal center axis of the third revolute joint pin and a fourth longitudinal center axis of the fourth revolute joint pin are configured to be orthogonal to each other in a same plane parallel to ground.

10. The vehicle driving system of claim 7, wherein a first longitudinal center axis of the first revolute joint pin and a third longitudinal center axis of the third revolute joint pin are configured to be parallel to each other in a same plane parallel to ground.

11. The vehicle driving system of claim 7, wherein a second longitudinal center axis of the second revolute joint pin and a fourth longitudinal center axis of the fourth revolute joint pin are configured to be parallel to each other in a same plane parallel to ground.

12. The vehicle driving system of claim 7, wherein the first revolute joint pin and the fourth revolute joint pin are configured to be located at points symmetrical to each other relative to the rim in a same plane parallel to ground.

13. The vehicle driving system of claim 7, wherein the second revolute joint pin and the third revolute joint pin are configured to be located at points symmetrical to each other relative to the rim in a same plane parallel to ground.

14. The vehicle driving system of claim 1, wherein the rotational center shaft protrudes from outer surfaces of the rim so as to be inserted into an insertion groove formed in each of the first knuckle and the second knuckle.

15. A vehicle driving system comprising:
a driving/braking system comprising an in-wheel motor and an electromechanical brake installed at a rim inner side of a wheel rim;
a steering system; and
a suspension system coupled to a wheel rotation shaft of the wheel rim, wherein the steering system is at an upper portion of the suspension system, wherein the suspension system comprises:
a first knuckle coupled to a first shaft end of the wheel rotation shaft,
a first dampener connecting the steering system to the first knuckle;
a second knuckle coupled to a second shaft end of the wheel rotation shaft, wherein the second shaft end is opposite the first shaft end with respect to the wheel rim, and
a second dampener connecting the steering system to the second knuckle.

16. The vehicle driving system of claim 15, wherein the suspension system further comprises:
a third dampener connecting the steering system to the first knuckle, wherein the third dampener is separated from the first dampener by a first spaced distance such that the first shaft end of the wheel rotation shaft is located between the first dampener and the third dampener; and
a fourth dampener connecting the steering system to the second knuckle, wherein the fourth dampener is separated from the second dampener by a second spaced distance such that the second shaft end of the wheel rotation shaft is located between the second dampener and the fourth dampener.

17. The vehicle driving system of claim 15, wherein the steering system comprises:
a worm wheel having a lower portion coupled to the first dampener and the second dampener; and
a worm gear engaging the worm wheel.

18. A vehicle driving module comprising:
a driving/braking system comprising an in-wheel motor and an electromechanical brake installed at a rim inner side of a wheel rim;
a steering system; and
a suspension system coupled to a wheel rotation shaft of the wheel rim, wherein the steering system is at an upper portion of the suspension system, wherein the suspension system comprises:
a first knuckle coupled to a first shaft end of the wheel rotation shaft, wherein the first knuckle has a first coupling hole therein and a second coupling hole therein,
a first dampener having a first-dampener first end coupled to the steering system and having a first-dampener second end in the first coupling hole of the first knuckle, wherein the first coupling hole is sized to provide a first clearance between the first-dampener second end of the first dampener and the first knuckle,
a first revolute joint pin coupling the first-dampener second end of the first dampener to the first knuckle in the first coupling hole,
a second dampener having a second-dampener first end coupled to the steering system and having a second-dampener second end in the second coupling hole of the first knuckle, wherein the second coupling hole is sized to provide a second clearance between the second-dampener second end of the second dampener and the first knuckle,
a second revolute joint pin coupling the second-dampener second end of the second dampener to the first knuckle in the second coupling hole,
a second knuckle coupled to a second shaft end of the wheel rotation shaft, wherein the second knuckle has a third coupling hole therein and a fourth coupling hole therein,
a third dampener having a third-dampener first end coupled to the steering system and having a third-dampener second end in the third coupling hole of the second knuckle, wherein the third coupling hole is sized to provide a third clearance between the third-dampener second end of the third dampener and the second knuckle,
a third revolute joint pin coupling the third-dampener second end of the third dampener to the second knuckle in the third coupling hole,
a fourth dampener having a fourth-dampener first end coupled to the steering system and having a fourth-dampener second end in the fourth coupling hole of the second knuckle, wherein the fourth coupling hole is sized to provide a fourth clearance between the fourth-dampener second end of the fourth dampener and the second knuckle,
a fourth revolute joint pin coupling the fourth-dampener second end of the fourth dampener to the second knuckle in the fourth coupling hole.

19. The vehicle driving module of claim 18, wherein a first longitudinal center axis of the first revolute joint pin and a second longitudinal center axis of the second revolute joint pin are disposed to be orthogonal to each other in a first horizontal plane, and
wherein a third longitudinal center axis of the third revolute joint pin and a fourth longitudinal center axis of the fourth revolute joint pin are disposed to be orthogonal to each other in the first horizontal plane.

20. The vehicle driving module of claim 19, wherein the first longitudinal center axis of the first revolute joint pin and the third longitudinal center axis of the third revolute joint pin are disposed to be parallel to each other in the first horizontal plane, and
wherein the second longitudinal center axis of the second revolute joint pin and the fourth longitudinal center axis of the fourth revolute joint pin are disposed to be parallel to each other in the first horizontal plane.
